(19) United States
(12) Patent Application Publication
(10) Pub. No.: US 2005/0139088 A1
(43) Pub. Date: Jun. 30, 2005

(54) Enclosed steam cooker

(76) Inventors: Neville Adolphus Nelson, Monroe Township, NJ (US); Sherwin Arlon Nelson, Monroe Township, NJ (US); Sherlon Arleigh Nelson, Monroe Township, NJ (US)

Correspondence Address: Neville Adolphus Nelson, 6 Tanglewood Place East, Monroe Township, NJ, 08831-3267, US

(21) Appl. No.: 10/748,069

(22) Filed: Dec. 29, 2003

(51) Int. Cl. A47J 37/12

(52) U.S. Cl. 99/403

(57) ABSTRACT

An enclosed steam cooker comprising of a cookware with lower compartment having a ceiling and floor where at least a portion of the space is occupied by a liquid and the remaining space is depressurized. When heat is applied to the lower compartment of the cookware the steam that arises from the liquid will cook but not burn the food.

### BACKGROUND OF THE INVENTION

1. Field of the Invention

The present invention relates to a steam cooker that utilizes steam to cook food.

2. Description of the Related Art

Methods of cooking changes over time as well as the utensils used. But, what has not changed is the prevention of food from being burnt in many cases. Currently the utensils readily available have features such as nonstick, but what these utensils still have not been able to prevent is the burning of food. In many instances, cookware can and will burn food if left unattended for some period of time, therefore it is desirable to provide cookware to help in the prevention of burning food.

### SUMMARY OF THE INVENTION

The present invention provides a cookware that helps in the elimination of burning food. In particular, the cookware is comprised of approximately ⅝ of an inch of space at the lower compartment of the cookware, with approximately ½ of an inch of water and the remainder being depressurized space.

### BRIEF DESCRIPTION OF THE DRAWINGS

FIG. 1 shows an exploded side view of the enclosed steam cooker of the present invention;

FIG. 2 shows a cross-section of the inner and outer portion of the enclosed steam cooker of the present invention;

FIG. 3 shows a perspective cross-section of the inner and outer portion of the enclosed steam cooker of the present invention;

### DETAILED DESCRIPTION

The present invention provides a cookware that helps in the elimination of burning food. In particular, the cookware is comprised of approximately ⅝ of an inch of space at the lower compartment of the cookware, with approximately ½ of an inch of water and the remainder being depressurized space.

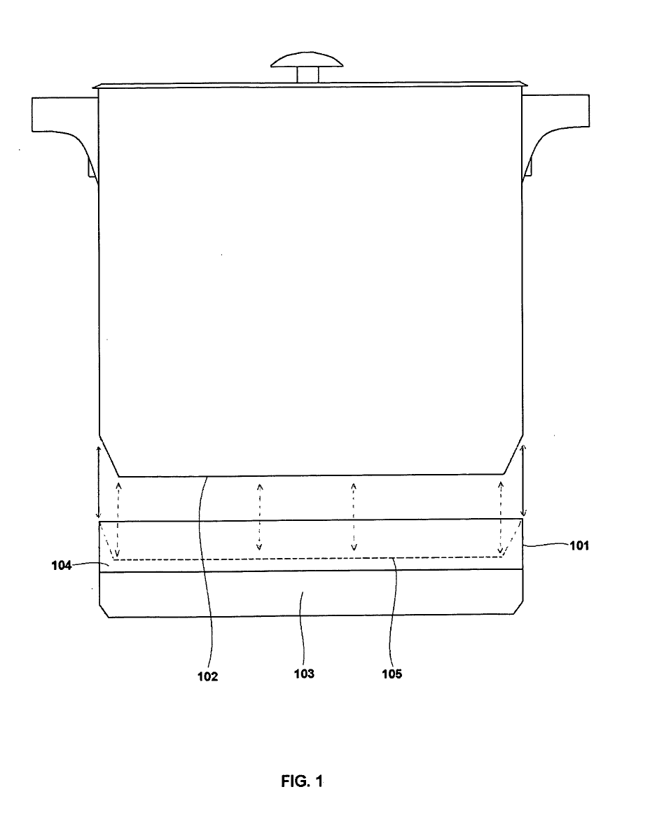

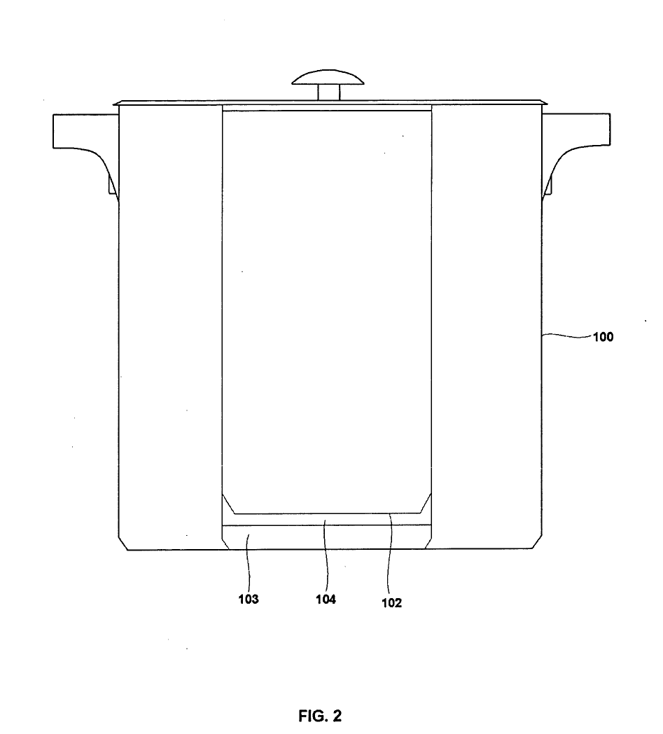

Referring to FIG. 1, there is shown an exploded side view of the enclosed steam cooker of the present invention, comprised of a lower compartment 101 and an upper compartment 102; both compartments preferably made from a rust resistant material (e.g., stainless steel) alloy and/or metal. It should be noted that the surface of lower compartment 101 is shown as a see through depiction so as to allow one to view the inside of lower portion 101. Contained in the lower compartment of 101 is material 103 which is water along with depressurized space 104. Space 104 is depressurized to ensure that material 103 (water) boils faster and produces steam, which transmits heat to the bottom of upper compartment 102. Indentation 105 is the location of where the upper compartment 102 will be when upper compartment 102 and lower compartment 101 are permanently sealed together creating the enclosed steam cooker 100 (not shown in FIG. 1; see FIG. 2). It will be readily obvious to one of ordinary skill in the art to which this invention belongs that other well known materials can be used in its creation, e.g. PYREX®.

Referring to FIG. 2, there is shown a cross-section of the inner and outer portion of the enclosed steam cooker of the present invention. There is shown an area for liquid such as water 103, depressurized space 104, and upper compartment 102 of the enclosed steam cooker 100.

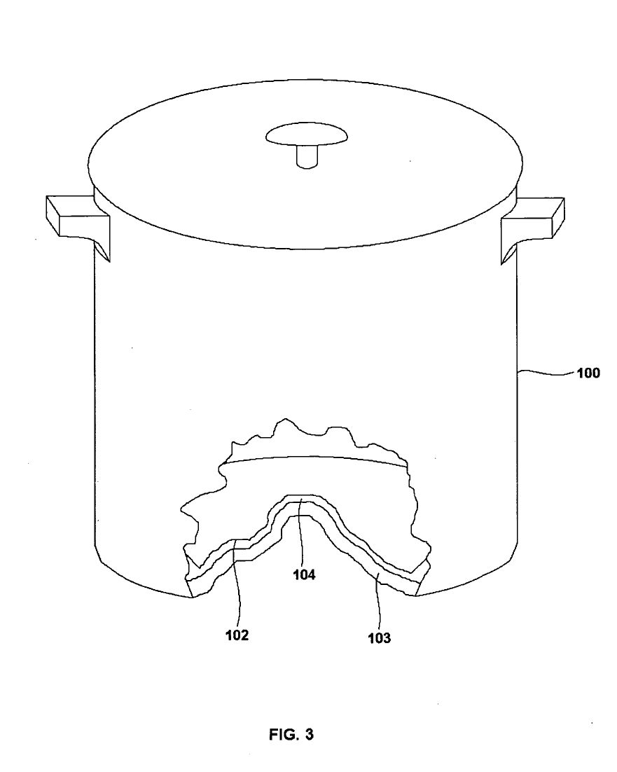

Referring to FIG. 3, there is shown a perspective cross-section of another embodiment of the enclosed steam cooker of the present invention. As noted in FIG. 2 there is shown an area for liquid such as water 103, depressurized space 104, and upper compartment 102 of the enclosed steam cooker 100.

It will be readily understood that various designs of the enclosed steam cooker of the present invention although not shown or discussed in detail fall within the scope of the claims of this invention. The enclosed steam cooker of the present invention comprises a cookware in which a liquid that produces steam when heated is enclosed within a lower compartment of the cookware having a ceiling and floor within said compartment.

1. An enclosed steam cooker comprising:
a cookware with lower compartment;
having a ceiling and floor where at least a portion of the space is occupied by a liquid and the remaining space is depressurized.

2. The enclosed steam cooker of claim 1 where the lower compartment is permanently attached to the cookware.

3. The enclosed steam cooker of claim 1 does not have to be refilled with liquid in the lower compartment of cookware once permanently attached.

4. The enclosed steam cooker of claim 1 cooks food by steam (produced by liquid in lower compartment) which transmits heat through ceiling of said compartment.
